(19) United States
(12) Patent Application Publication
(10) Pub. No.: US 2018/0078968 A1
(43) Pub. Date: Mar. 22, 2018

(54) Apparatus and method for painting three-dimensional objects

(71) Applicants: Andrea Luca Guiduzzi, Massa Lombarda (RA) (IT); Hrvatin Bertolovic, Rimini (IT)

(72) Inventors: Andrea Luca Guiduzzi, Massa Lombarda (RA) (IT); Hrvatin Bertolovic, Rimini (IT)

(73) Assignee: CEFLA SOCIETÁ COOPERATIVA, Imola (BO) (IT)

(21) Appl. No.: 15/283,077

(22) Filed: Sep. 30, 2016

(30) Foreign Application Priority Data
Sep. 16, 2016 (EP) 16189129

(51) Int. Cl. B05D 1/02; B05D 3/04; B05D 3/06; B05B 15/06

(52) U.S. Cl. CPC B05D 1/02; B05B 15/061; B05D 3/06; B05D 3/0413

(57) ABSTRACT

A painting apparatus for painting objects having three comparable dimensions includes a paint delivery system delivering paint supplied by an external system. The paint delivery system is supported by a carriage which, through an axle, moves on a guidance system having a shape that mimicks the shape of the object to be painted. The carriage is displaced along the guiding system by a controlled actuating system and the guidance system is optionally a hollow guide. A method for painting objects having three comparable dimensions is also disclosed.

### FIELD OF THE INVENTION

The present invention relates to apparatuses for painting objects. More particularly, the present invention relates to apparatuses for painting of three-dimensional objects like protective helmets, vases, etc.

### BACKGROUND OF THE INVENTION

Machines for spray painting are known in the art. A typology of such machines applies paint on objects having two main dimensions, e.g. panels made of different materials like wood, plastics, fibro-cement, glass, and having typical dimensions of 6000 mm in length, width up to 1300-1500 mm and thickness up to 5-300 mm. In the present context, such objects are regarded as bi-dimensional objects.

Moreover, apparatuses are known for painting objects having three dimensions that are comparable to each other, i.e., having dimensions according to three axes orthogonal to each other, which are approximately of the same order of magnitude. Reference will be made herein to those objects as three-dimensional objects.

When three-dimensional objects have complex shapes, generally they are painted by human operators or by anthropomorphic robots, capable of following the shape of the object to be painted. A drawback of manual painting is the lack of repeatability, while anthropomorphic systems are very expensive.

The embodiments described herein relate to a system for painting motorcycle helmets, without for this losing generality, the fact that analogous concepts can be used for painting any three-dimensional object being apparent to the skilled person. It is worth noting that an aspect of a painting apparatus according to the present invention is the ability to manufacture a significant number of objects having a very similar shape.

Utility model CN2907912Y to Zeng Jian describes a painting plant for motorcycle helmets comprising a base structure, a bracket and a spraying gun following an arc of a circle.

U.S. Pat. No. 8,545,943B2 to Airbus GmbH describes a device for painting the curved surface of an object, comprising a device spraying paint with a guide and a control device.

An aim of this patent is obtaining a three-dimensional texture (riblets) of the paint applied on the object, an aim that is in contrast with an aim of the present invention, which is obtaining a very smooth and uniform painted surface.

### SUMMARY OF THE INVENTION

It is an object of the present invention to provide an apparatus and a method for painting three-dimensional objects.

This object is achieved by an apparatus and a method having the features described hereinafter. Advantageous embodiments and refinements will also be described hereinafter.

An apparatus for painting three-dimensional objects according to the present invention comprises:

A support for supporting the object to be painted, optionally capable of pivoting the object around its vertical axis; and

A guidance system supporting at least a delivery system of paints and varnishes; said guidance system, optionally in the form of a rail, having a shape mimicking, at least approximately, the shape of the object to be painted.

The aim of said guidance system or rail is that the trajectory of the paint delivery system is as similar as possible to the shape of the object to be painted: this would be easily obtained through a wheel sliding inside a hollow rail having the same shape of the object to be painted. Nonetheless, a single wheel sliding inside a rail does not confer the needed steadiness to the movement: it is necessary to have a carriage, which will impart to the paint delivery system a trajectory different from the shape of the object to be painted at the moment of change of radius of curvature. Said carriage comprises at least a couple of axles, e.g. wheels positioned along a same axis or shaft.

In an embodiment, said carriage comprises at least two axes, each of which carries at least a wheel, the two axes being at a distance from each other in the direction of forward motion of the carriage, and said two wheels being engaged in a guidance system having the shape of a slot.

The method according to the present invention comprises the following steps:

The three-dimensional object is placed on a support, optionally a pivoting, support;

The paint delivery system sprays the object placed on said support while the delivering system moves along the path imposed by a guidance system; and

The combination of the movement of the object and of the paint delivery system obtains a uniformly painted object.

A first advantage of the present invention is providing a very cheap apparatus for painting three-dimensional objects.

A second advantage of the present invention is providing an apparatus assuring a repeatable painting of very good quality of three-dimensional objects.

A third advantage of the present invention is the possibility of applying a more or less thick coating of paint in desired portions of the object, thanks to the control of the movement and to the translation speed of the painting gun.

### BRIEF DESCRIPTION OF THE DRAWINGS

Further advantages and properties of the present invention are disclosed in the following description, in which exemplary embodiments of the present invention are explained in detail on the basis of the drawings:

FIG. 1 illustrates a top view of a painting line for three-dimensional objects according to the invention;

FIG. 2 illustrates an axonometric view of the painting apparatus;

FIG. 3 illustrates a side view of the painting apparatus;

FIG. 4 illustrates a detail of the side view of the axis and of the carriage of the painting apparatus;

FIG. 5 illustrates a block diagram of a painting line according to the invention.

### DETAILED DESCRIPTION OF EMBODIMENTS OF THE INVENTION

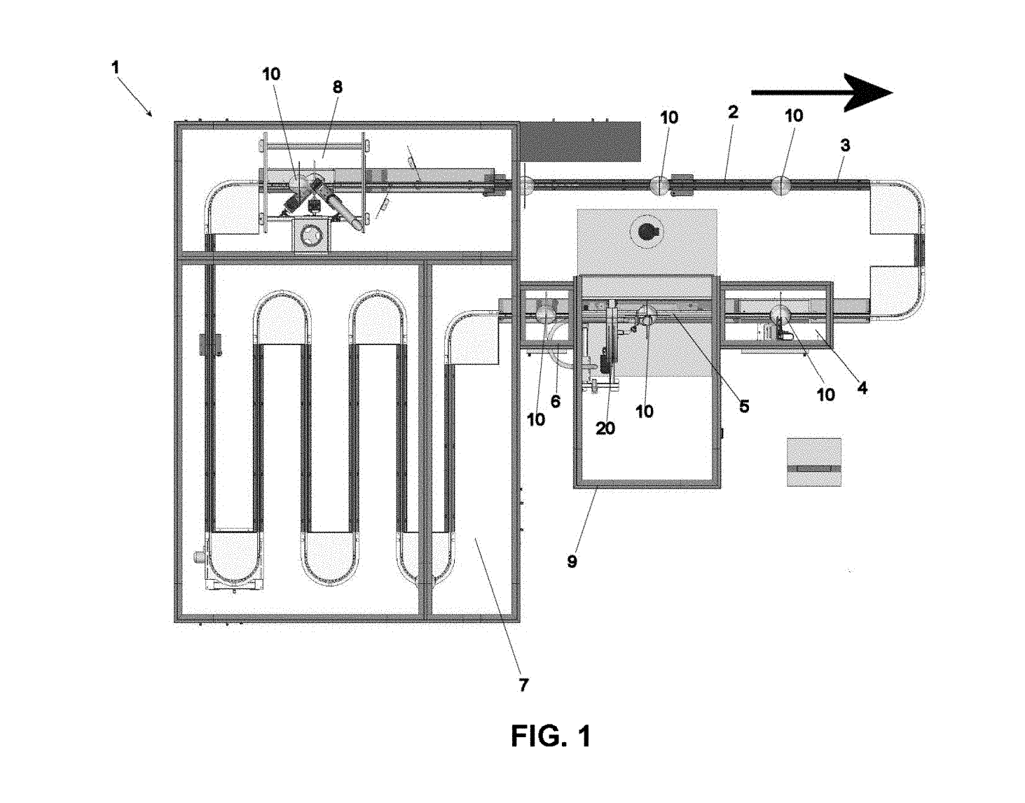

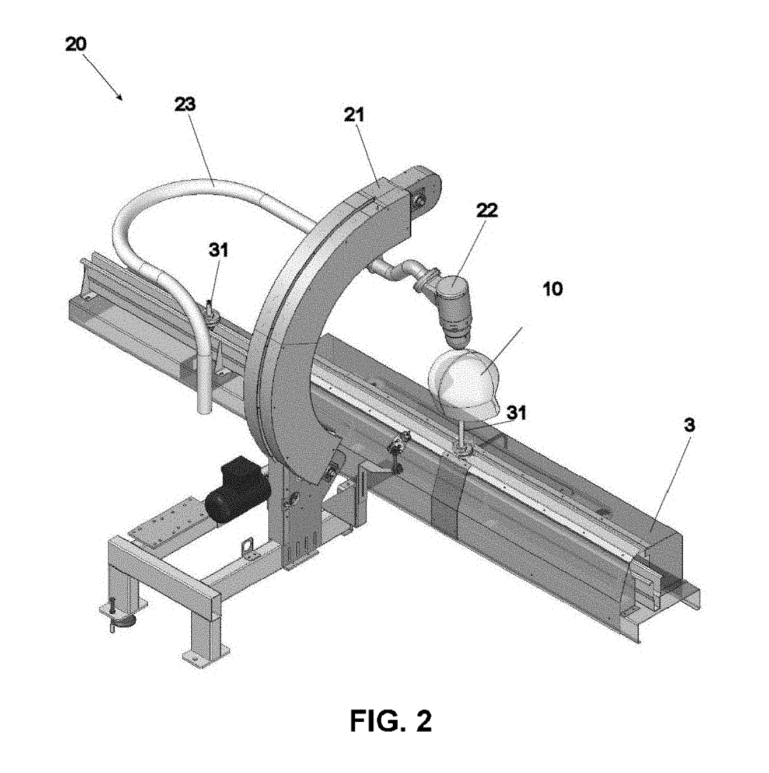

FIG. 1 shows a painting line 1 for painting three-dimensional objects 10, in an embodiment for painting motorcycle helmets, wherein 2 indicates a loading station of an object 10 to be painted on a suitable support 31, and therefore the position wherein the object 10 is uploaded into line 1. Said object 10 is loaded manually or through a robot (not shown) on a suitable support 31 (see FIG. 2) fixed on a rail system 3, thanks to which each support is shifted along a path passing through different working stations. Said rail system 3 can be a chain on a floor, a jib conveyor or an overhead conveyor.

Said object 10 to be painted shifts in the direction indicated by the arrow in FIG. 1. Said object 10 is shifted to a cleaning station 4. In said cleaning station, operations having the aim to prepare the surface to be painted are performed; e.g. the object to be painted is blown with compressed air, or washed, or electrostatically treated (ionized or de-ionized), or treated by a combination of said operations. In a preferred embodiment, while said object 10 undergoes cleaning, it pivots around its vertical axis.

Cleaning can occur through different treatment means, like a circuit supplying detergent agents, provided with one or more spraying nozzles and/or a circuit supplying rinsing agents, provided with one or more spraying nozzles. The two circuits can be distinct, and have dedicated spraying nozzles, or they can share at least the spraying nozzles, valves being provided at least for alternatively connecting said nozzles to supplying pipes of said substances. In combination to the above, heating means can be provided for detergent and/or rinsing liquid or gases or vapors.

In a further embodiment, the cleaning station can be provided with a drying system which can supply e.g. an air flow for drying. In combination, means for heating said air flow can be provided. Another alternative can provide drying means through radiation.

From here, the object to be painted is further shifted to a painting station 5. Said painting station 5 comprises a booth 9 and a painting apparatus 20 for three-dimensional objects 10. Providing such painting apparatus is an object of the present invention. It should be noted that the painting of objects 10 in the painting station 5 occurs inside a closed booth 9 supplied with treated air.

Optionally, after said painting station 5, said object 10 is displaced in a station 6 where it can be observed by a human operator to check painting quality.

From here, said object 10 is further moved to a drying station 7, where it undergoes the action of air having a temperature adjusted according to the features of the paint or varnish being used.

Said object 10 continues its path and is moved to a curing station 8, where it undergoes the action of radiations having suitable wavelength (e.g. ultraviolet or infrared), still according to the paint or varnish used.

Said object 10 goes back to the starting station 2 in order to be removed from painting line 1, manually or through a robot (not shown). Now the path of an object 10 to be painted inside the painting line 1 is complete.

FIG. 2 shows the painting apparatus 5 in an axonometric view. For better clarity, the booth 9 was removed.

The object 10 to be painted is supported on a suitable support 31, which, in a preferred embodiment, can pivot on its vertical axis.

Different embodiments of support 31 can be provided, depending on the kind of object to be painted.

In an embodiment, the support 31 comprises a substantially vertical support shaft, which is rotatably supported around its axis, and which is provided with coupling organs to an object 10. The coupling organs are provided with coupling components to at least some areas of said object and are configured to orient said object according to a pre-set position relative to the supporting shaft.

In a further advantageous embodiment, coupling organs are such that they cooperate with said object 10 holding it in a position such that the shaft axis has a pre-set position with respect to an axis of symmetry of said object.

Preferably, in one embodiment, the axis of said supporting shaft is oriented parallel to an axis of symmetry of said object 10, and preferably is coinciding with said axis of symmetry.

In the illustrated embodiment, in which the object 10 is a helmet and has a substantially spherical shape, the axis of the supporting shaft is substantially coinciding with the rotational axis of symmetry of helmet spherical surface, which is transversally oriented to the open side of said helmet.

In the specific embodiment, wherein the object to be painted is a helmet or an object having a cylindrical or spherical or spheroidal rotational symmetry, made of a shell or a cape surface, the coupling elements may be in the form of convex objects or cups or semi-shells having a shape substantially corresponding to the shape of the compartment defined by the internal surface of said object.

In a further improvement, at least part of said convex objects, cups or shells forming the coupling element are alternatively expandable and retractable, so as to exert at least some blocking force of the object on said elements.

In one embodiment, said object pivots around its vertical axis for at least 180°. In an alternative embodiment, the objects pivots around its vertical axis for 360°. In a preferred embodiment the objects performs a plurality of rotations, i.e. pivots around its vertical axis for at least 360°.

The supports 31 of the objects 10 to be painted are conveyed by rail 3. Painting can occur both with a discontinuous (stop and go) conveying system, where the object 10 stops in the painting station 5 for a pre-set time, and with a continuous conveying system, where the painting station 5 “chases” the object 10 for a pre-set time, i.e. the painting takes place while the object 10 is shifting.

In this case, the supplying system 22 only, i.e. the supplying or spraying head only or the entire painting unit, as it will be described in regard to one embodiment, includes the guidance system. The components needed for operation of the spraying unit, such as electrical, hydraulic and other supplies, are mounted in a displaceable way along path in the direction of the forward movement of supports 31, i.e. of each support 31 entering in the painting station 5.

Said booth 9 can have a length that enables a shifting of the painting unit, or said booth 9 itself can shift with the painting unit for the portion of path needed for accompanying a support 31 with the object to be painted supported on it, so as to perform the complete painting process of said object.

The painting apparatus 20 comprises a longitudinal axis 21 having a pre-defined path and supporting a spraying gun 22, supplied by a tubing 23 connected to a supply system (not shown) for supplying the paint or varnish.

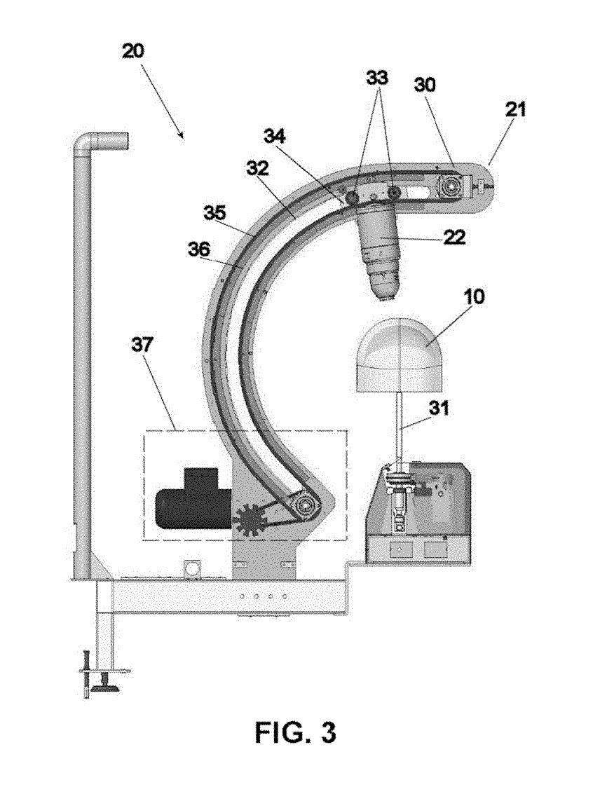

FIG. 3 shows a lateral view of the apparatus 20, in which housings were removed for better clarity.

The painting apparatus 20 comprises an arm 30 on which a hollow guidance system 32 is obtained, i.e. a slot extending along the longitudinal extension of said arm 30, where axles 33, positioned on a carriage 34, are engaged and move. Said carriage 34 is dragged by a continuous dragging element like a belt or chain 35, lying on a chain guide 36. Said chain is moved by a motor control 37. Said motor control 37 actuates in rotation at least a first return pulley in correspondence of one of the ends of the guidance system 32, while the dragging element is returned around a second return pulley, which can be motorized or not, and which is provided at the other end of the guidance system 32.

In one embodiment, the return pulleys are placed directly adjacent at the corresponding end of the guidance system 32. Said carriage 34 supports a spraying gun 22.

In the present embodiment, a helmet 10 is painted while pivoting integrally with its support 31 for at least 360°. In alternative embodiments, painting may be performed while said object 10 is stationary or is in transit, as described above in detail.

In the embodiment wherein the object 10 to be painted pivots, there is an advantage connected to the overspray which forms inside the booth. When all the objects 10 inside booth 9 pivot around their axis, the overspray uniformly distributes on the object 10 immediately before and immediately after the one painted at that moment, which are still inside booth 9.

In this case, the extension of the painting booth 9, with respect to the distance of at least two successive supports 31 for an object to be painted, is such to house inside at the same time at least one of said object to be painted in the working position with respect to the spraying gun 22, while at least an additional object to be painted is housed adjacently at the same time inside said spraying booth 9.

In the presently described embodiment, said spraying gun 22 follows a roundtrip on the longitudinal axis 21 to paint a single object 10. In alternative embodiments, the gun 22 might follow a path along one direction only, or a plurality of roundtrips.

The actuating group 37 can control the speed of the chain moving the carriage 34 and, therefore, of the gun 22, so said gun 22 can linger for a longer time in positions of the axis 21 according to needs related to the specific object 10 to be painted. In other words, said gun 22 can accelerate or decelerate according to its position on said axis 21.

In one embodiment a brushless motor can be employed, providing for an electronic control of motor rotation speed due to a suitable control and supply circuit providing an input of speed set-up, according to which a processor controls the generator of the supplying signal of the motor.

Alternative embodiments are possible, in which speed regulators of resistive electric motors are provided, always operating according to a variation of the electrical supply signal of the motor, or mechanical speed regulators.

The gun 22 maintains a fixed position with respect to the carriage 34. In the present embodiment, the gun 22 is positioned perpendicularly to carriage 34, but in alternative embodiments, the gun might have a different tilting angle with respect to said carriage.

In the illustrated embodiments, the spraying gun 22 is oriented so that the paint jet is oriented towards the surface of the object to be painted always with the same angle of attack with respect to the tangent of the surface of said object oriented towards said paint jet and at the point of attack of said object.

In one embodiment, the paint jet has a propagation axis which is substantially perpendicular to said tangent, possibly substantially for a preponderating portion of the path of spraying gun 22 along guidance system 32.

In an alternative embodiment, the gun 22 is connected to the carriage 34 in a variable way, through an actuator (not shown), which enables a variation of its tilting angle with respect to carriage 34 during its translation in the guidance system 32. In other words, the tilting of the gun is dependent on its position on axis 21.

The form of the guidance system 34 is appropriately chosen according to the shape of the object 10 to be painted so that said path is parallel or substantially coaxial to the surface of the object 10 along the section plane of said object, coinciding with the plane containing the guidance system 32 and the axis of the painting jet of spraying gun 22.

In the present embodiment, it can be observed that the shape of the guidance system 32 follows the shape of the motorcycle helmet 10 with an offset.

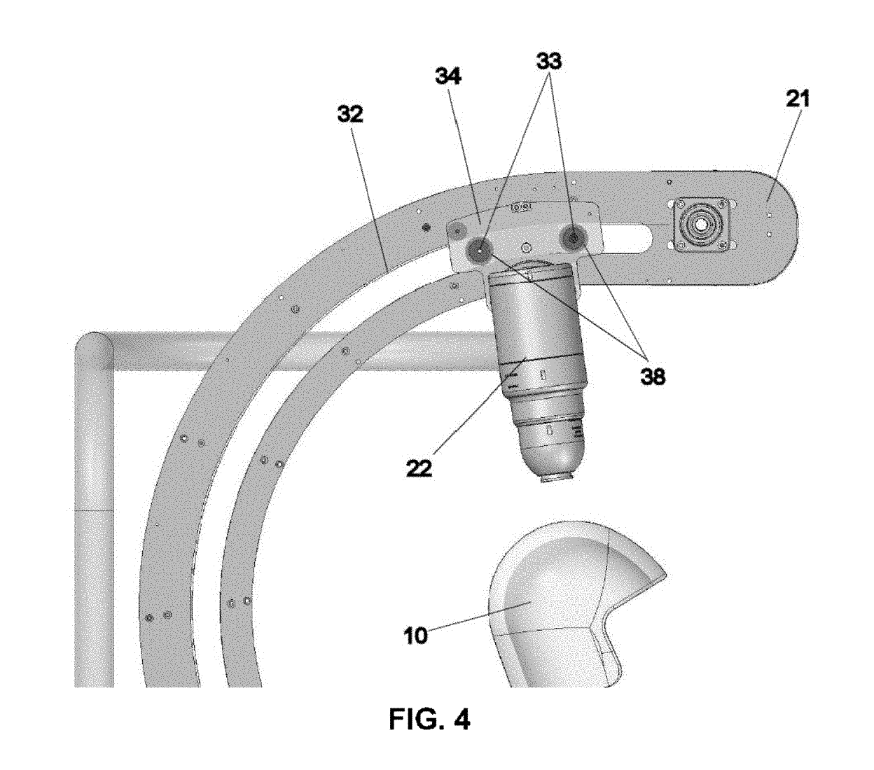

FIG. 4 better clarifies the movement of the carriage 34 inside the hollow guidance system 32. The wheels 38 are fixed to axles 33, and following the curve of the guidance system 32, confer a movement to carriage 34.

The shape of the object 10 to be painted determines the shape of the guidance system 32. Therefore, in apparatuses for painting objects different from helmets, the shape of said guidance system 32 may be different from that shown in FIGS. 2 and 3. In case of a different object, said guidance system will have a shape which is the result of the combination of linear and curved segments according to shape of the object to be painted, so that the path of the spraying gun 22, i.e. of the attack point of the paint jet generated by said gun, is substantially corresponding to the shape of the object to be painted.

In an alternative embodiment, two guidance system can be present, each of which carries a pair of wheels, and by managing the offset between the guidance systems, variable inclinations of the gun axis can be obtained. In other words, the paths of the two guidance systems may be not parallel to each other.

In other words, an embodiment is provided with two hollow guidance systems, each of which carries an axle 33 of a carriage 24 slidable along said guidance systems, said two guidance systems being movable with respect to each other in a direction that provides for a variation of the arrangement of the carriage 34, such as a tilting, so that modifying the relative offset position between said hollow guidance systems 32, a variable tilting of the painting system axis 22 can be obtained, the paths of the side by side guidance system being preferably not parallel.

In the presently described embodiments of a painting line for motorcycle helmets, helmets having markedly different dimensions can be painted (e.g. child helmets and adult helmets, having helmet diameters that may vary from 300 to 400 mm). In this case, the painting apparatus 20 can be adjusted changing the offset between the gun 22 and the carriage 34: in other words, the gun is approached to, or distanced from, the object to be painted.

In one embodiment, the gun 22 can have at least a telescopically extendable and retractable segment, e.g. the support end of the nozzle 422 is made of two telescopically coupled tubes 522 and 622, one of which supports the nozzle and the other one connects to the remaining part of the gun.

Said adjustment can be made manually, or with system that is motorized and controlled through an input control.

Alternatively and/or in combination with the manual control, a sensor or a combination of sensors can be provided, detecting the dimensions of the objects to be painted and sending corresponding input signals for the position of the painting nozzle with respect to carriage 34 to an electronic control unit, which in turn controls the motorized system for adjusting the position of said nozzle, e.g. the stretching condition of the telescopic element of spraying gun 22.

As sensors of the dimensions of the object to be painted, proximity sensors mounted on measuring portals or cameras shooting the object to be painted according to at least an angle can be used, which, based on detection algorithms, detect the typology and the dimensions of the acquired object, generating the input signal for the input control unit of the system, which in turn controls the correct position of the spraying nozzle.

In one embodiment, the input unit or an additional control unit comprises a processor, which performs a detecting program for objects in the images to identify the kind and the dimension of the object acquired through said cameras, and which sends the result of the shape and dimensions of the object to be painted that were acquired in the images of the input control unit.

The features of the paint or varnish employed and the kind of gun employed might request an adjustment of the spraying position with respect to the object to be painted as well. For example, approaching or distancing the spraying system to the object may become necessary.

In a preferred embodiment, wherein an actuation system is provided for varying the distance between spraying gun and object to be painted, said distance can be varied in two modalities:

The distance between the object to be painted and the paint delivery system may be changed before the beginning of paint delivery; in other words, the distance between the object and the paint delivery system remains constant for the entire painting time of said object; or

The distance between object to be painted and paint delivery system is changed during paint delivery; in other words, the distance between the object and the paint delivery system varies during the painting of a single object. This possibility of variation makes painting quality even better.

In other embodiments, different kinds of paint delivery systems may be used, e.g. pneumatic spraying guns, HVLP (High Volume Low Pressure) spraying guns, air-assisted spraying guns, airless spraying guns, or rotary bells.

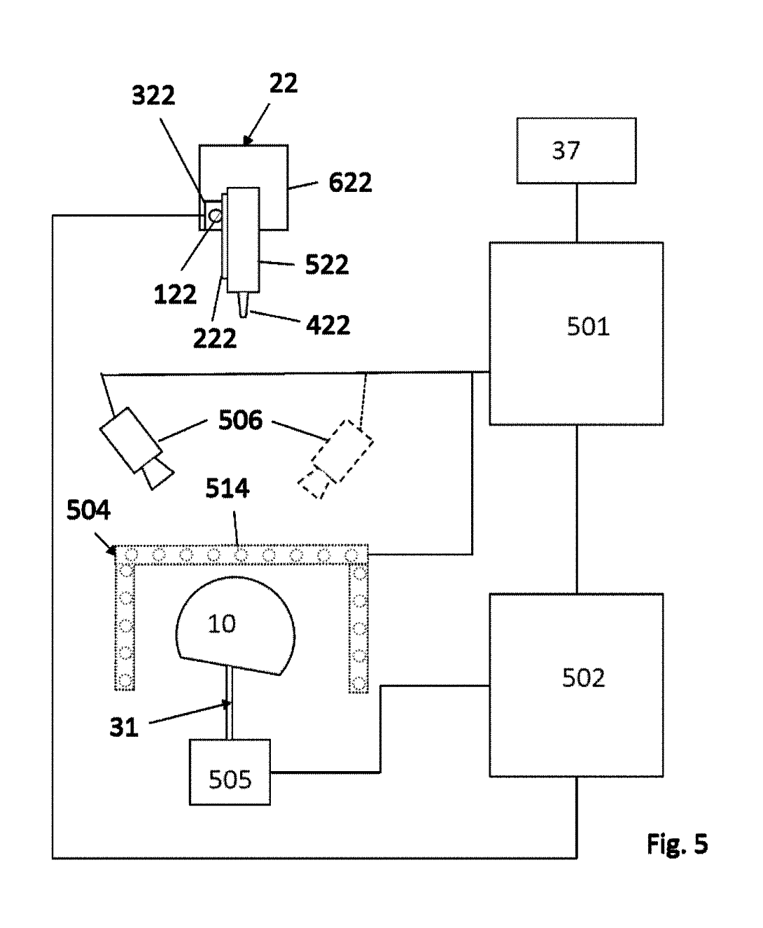

FIG. 5 illustrates an embodiment of a line according to the present invention related to the above-described input system.

The hereunder illustrated system is only one of different possible embodiments.

An input unit 501 performs a program configuring the system, and has both manual input units of configuration data and configuration variables such as, for example. and without limitation, one or more of the following data: speed of movement of carriage 34, distance between nozzle and/or gun 22 and surface of the object to be painted 10, moving speed of supports 31, speed and number of rounds of supports 31, and possible tilting of painting jet or of gun 22.

A processing unit 502 processes the data detected by one or more cameras 506 or a portal 504 with proximity sensors or optical sensors 514 for determining the dimensions and/or the shape of the object 10 to be painted, and generates signals corresponding to said shape and dimensions, which are provided to the input unit 501. The input unit 501 performs a control program according to which, from these shape and dimensional data, input data are generated for setting the position of the nozzle on the spraying gun 22 and/or the rotation speed and/or the angular width of rotation of support 31 and/or the forward movement and of the repetitions of roundtrips on said path of the gun 22 and/or of the tilting of gun 22 or of its axis with respect to the object 10 to be painted.

In the illustrated example, the input unit 501 generates control signals of the motor 37 actuating the dragging chain of carriage 34, of the actuating motor 322 of a pinion 122 cooperating with a rack 222, through which two telescopic tubes 522 and 622 of the spraying gun 22 are axially moved, one of the tubes supporting at its end a nozzle 422, and control signals of the actuating rotating motor 505 of each support 31 for each object to be painted.

When each object to be painted enters into the line, its shape and dimensions are detected, and the position of the nozzle with respect to the surface to be painted and therefore with respect to carriage 34 or guidance system 32, the angular width of the rotation of support 31, the path along the guidance system and the number of repetition, and even the speed of the movement of carriage 34 and/or the angle of attack of the axis of the paint jet supplied by spraying gun 22 are set accordingly.

It should be noted that, in addition to said parameters, it is possible to also input other configuring parameters of the line.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

### TABLE OF REFERENCE NUMBERS

1 Painting line
2 Loading and unloading station
3 Rail system
4 Cleaning station
5 Painting station
6 Visual inspection station
7 Air-drying station
8 Curing station
9 Painting booth
10 Object to be painted
20 Painting apparatus
21 Axis
22 Spraying gun
23 Piping
30 Arm
31 Support for object to be painted
32 Guidance system
33 Axle
34 Carriage
35 Chain
36 Chain guide
37 Actuating group
122 Pinion
222 Rack
322 Motor
422 Nozzle
501 Input unit
502 Processing unit
504 Portal
505 Rotation motor
506 Camera
514 Optical sensor
522 First telescopic segment
622 Second telescopic segment

1. A painting apparatus (20) for painting objects (10) having three comparable dimensions, comprising:
a paint delivery system (22) delivering paint supplied by an external system; and
a carriage (34) supporting the paint delivery system (22), the carriage, through at least an axle, (33) moving on a guidance system (32) that has a shape mimicking a shape of an object (10) to be painted,
wherein the carriage (34) is displaced along the guidance system (32) by a controlled actuating system (37).

2. The painting apparatus (20) according to claim 1, wherein, during painting, the object (10) to be painted is made to pivot around an axis.

3. The painting apparatus (20) according to claim 2, wherein the axis is a central axis and is oriented in an incident direction with respect to the guidance system (32), the axis being substantially contained in a same plane as, or in a plane parallel to, a plane containing a central longitudinal axis of the guidance system (32).

4. The painting apparatus (20) according to claim 2, wherein the axis is a vertical axis of the object (10) and rotation occurs for an angular width of at least 180°.

5. The painting apparatus (20) according to claim 4, wherein the rotation occurs for an angular width of preferably of 360° or more.

6. The painting apparatus (20) according to claim 2, wherein the painting apparatus paints the object (10) while the object (10) is in stationary position; while the object is in a stationary condition in relation to the guidance system (32) and rotates around the axis only; while the object (10) transits in front of the apparatus (20); or while the object moves in a pre-set direction in relation to the guidance system (32).

7. The painting apparatus (20) according to claim 1, wherein the guidance system is a hollow guide.

8. The painting apparatus (20) according to claim 1, wherein the controlled actuating system (37) varies a speed of said carriage (34) according to a position of the carriage along the guidance system (32).

9. The painting apparatus (20) according to claim 1, wherein said paint delivery system (22) is a pneumatic spraying gun, a HVLP (High Volume Low Pressure) spraying gun, an air-assisted spraying gun, an airless spraying guns, or a rotary bell.

10. The painting apparatus (20) according to claim 1, wherein said paint delivery system (22) is movable to be approached to, or distanced from, the object (10).

11. The painting apparatus (20) according to claim 1, wherein said paint delivery system generates a supply jet transversally oriented with an angle of 90°, or different from 90° with respect to the carriage (34), or with respect to a tangent or a secant of a path of the carriage along the guidance system (32) in a position of the carriage (34).

12. The painting apparatus (20) according to claim 1, further comprising a second actuating system varying a position of the paint delivery system (22) in relation to the carriage (34).

13. The painting apparatus (20) according to claim 1, wherein painting of a single object (10) to be painted occurs through a path of the paint delivery system (22) along a longitudinal axis (21) in a single direction, during a single roundtrip, or during a plurality of roundtrips.

14. The painting apparatus (20) according to claim 1, wherein two guidance systems (32) are provided, each of which carries an axle (33) of the carriage (34) slidable along said guidance systems, said two guidance systems (32) being movable with respect to each other in a direction such to determine a variation of position or a tilting of said carriage (34), so that by varying an offset between said two guidance systems (32), variable inclinations of the paint delivery system (22) are obtained

15. The painting apparatus (20) according to claim 14, wherein the two guidance systems are two hollow guides and the paths of the two guidance systems are not parallel to each other.

16. A method for painting objects (10) having three comparable dimensions, the method comprising:
providing a painting apparatus according to claim 1;
providing a rotating support (31) for an object (10) to be painted according to an axis having a first direction;
providing a paint supply system (22) comprising a painting jet movable in a transversal direction along a moving path;
providing the moving path with a course at least partially parallel to a course of a surface to be painted of the object, in a plane containing the moving path and intersecting the object to be painted, so that the painting jet follows a path along the surface of the object;
placing a three-dimensional object (10) to be painted on the support (31);
activating the paint supply system (22) to supply a paint jet oriented towards the object to be painted, and simultaneously moving of the paint supply system (22) along the path; and
simultaneously activating a rotation of the object to be painted, so that a movement of the object (10) and a movement of the paint supply system (22) cooperate to achieve a uniform painting of the object.

17. The method according to claim 16, wherein the painting jet movable in the transversal direction perpendicular to a tangent or a secant of the moving path according to a polygonal or curved line between an initial position and a final position.

18. The method according to claim 16, further comprising the step of painting the object (10) while the object (10) is in stationary position, while the object (10) is stationary relative to the paint supply system (22), or while the object transits in front of the paint supply system (22) along the moving path.

19. A painting line (1) for painting objects (10) having three comparable dimensions, wherein said objects (10) are moved along a forward path on a line (1) using supports (31) supporting the objects (10) led along said path, the painting line comprising:
a loading/unloading station (2) where an object (10) to be painted is placed, and subsequently removed, on/from a support (31);
a cleaning station (4) for the object (10);
a painting station (5) comprising a painting apparatus (20) according to claim 1 placed inside a booth (9);
an optional station (6) for visual inspection of the painting;
a drying station (7) through air; and
a curing station (8) of applied paint through radiation.

20. The painting line (1) according to claim 19, wherein the support is positioned an a rail system (3) that is a chain on a floor, a jib conveyor, or an overhead conveyor.
